(19) United States
(12) Patent Application Publication
(10) Pub. No.: US 2026/0050463 A1
(43) Pub. Date: Feb. 19, 2026

(54) Generating Resource Deployment Health Report Graphs for Container-Based Environments

(71) Applicant: International Business Machines Corporation, Armonk, NY (US)

(72) Inventors: Jie Ke Fang, Beijing (CN); Cheng Wu, Beijing (CN); Jia Nan Zhang, Beijing (CN); Zi Qi Guan, Beijing (CN); Xiao Ling Chen, Beijing (CN)

(21) Appl. No.: 18/805,757

(22) Filed: Aug. 15, 2024

(51) Int. Cl. G06F 9/455

(52) U.S. Cl. CPC G06F 9/45558; G06F 2009/45591; G06F 2009/45595

(57) ABSTRACT

Generating resource deployment health report graphs for specific virtual deployments is provided. A resource deployment health report graph that defines each respective resource dependency and a status of each respective resource and each respective dependency resource in a virtual deployment of a container-based environment is generated prior to a plurality of resources corresponding to the virtual deployment being connected in the container-based environment. An analysis of information contained in the resource deployment health report graph is performed. It is determined whether each respective resource and each respective dependency resource in the virtual deployment is in a ready state based on the analysis. In response to determining that each respective resource and each respective dependency resource in the virtual deployment is in a ready state based on the analysis of the information, it is determined that an actual deployment reflected by the virtual deployment is in a healthy state.

### BACKGROUND

The disclosure relates generally to container-based environments and more specifically to deploying resources in a container-based environment.

A container-based environment, architecture, or platform, such as, for example, Kubernetes® (a registered trademark of the Linux Foundation of San Francisco, California, USA), provides a structure for automating deployment, scaling, and operations of application workloads across clusters of host nodes. Typically, a container-based environment includes, for example, a control node, which is a main controlling unit of a cluster of host nodes, managing the cluster's workload, and directing communication across the cluster. A host node is a machine, either physical or virtual, where an application workload is deployed. The host node hosts components of the application workload.

The control plane of the cluster of host nodes, which the control node forms, consists of various components, such as, for example, a data store, application programming interface (API) server, scheduler, and the like. The data store contains configuration data of the cluster, representing the overall and desired state of the cluster at any given time. The API server provides internal and external interfaces for the control node. The API server processes and validates resource availability (e.g., resource status) and updates state of objects in the data store, thereby allowing users to configure application workloads across host nodes in the cluster. The scheduler selects which host node a workload runs on.

### SUMMARY

According to one illustrative embodiment, a computer-implemented method for generating resource deployment health report graphs for specific virtual deployments is provided. A computer generates a resource deployment health report graph that defines each respective resource dependency and a status of each respective resource and each respective dependency resource in a virtual deployment of a container-based environment prior to a plurality of resources corresponding to the virtual deployment being connected in the container-based environment. The computer performs an analysis of information contained in the resource deployment health report graph. The computer determines whether each respective resource and each respective dependency resource in the virtual deployment of the container-based environment is in a ready state based on the analysis of the information contained in the resource deployment health report graph. In response to the computer determining that each respective resource and each respective dependency resource in the virtual deployment of the container-based environment is in a ready state based on the analysis of the information contained in the resource deployment health report graph, the computer determines that the actual deployment reflected by the virtual deployment is in a healthy state and that the actual deployment is successfully implemented in the container-based environment. According to other illustrative embodiments, a computer system and computer program product for generating resource deployment health report graphs for specific virtual deployments are provided.

### BRIEF DESCRIPTION OF THE DRAWINGS

FIG. 1 is a pictorial representation of a computing environment in which illustrative embodiments may be implemented;

FIG. 2 is a diagram illustrating an example of a resource deployment health report graph generation system in accordance with an illustrative embodiment;

FIG. 3 is a diagram illustrating an example of a resource deployment health report graph generation process in accordance with an illustrative embodiment;

FIG. 4 is a diagram illustrating an example of a resource dependency aggregation process in accordance with an illustrative embodiment;

FIG. 5 is a diagram illustrating an example of an operator in accordance with an illustrative embodiment;

FIG. 6 is a diagram illustrating an example of playbooks in accordance with an illustrative embodiment;

FIG. 7 is a diagram illustrating an example of a resource deployment health dependency graph in accordance with an illustrative embodiment;

FIG. 8 is a diagram illustrating an example of a resource deployment health report graph generation process in accordance with an illustrative embodiment;

FIG. 9 is a diagram illustrating an example of a resource deployment health report graph in accordance with an illustrative embodiment; and

FIGS. 10A-10D are a flowchart illustrating a process for generating a resource deployment health report graph corresponding to a specific virtual deployment in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

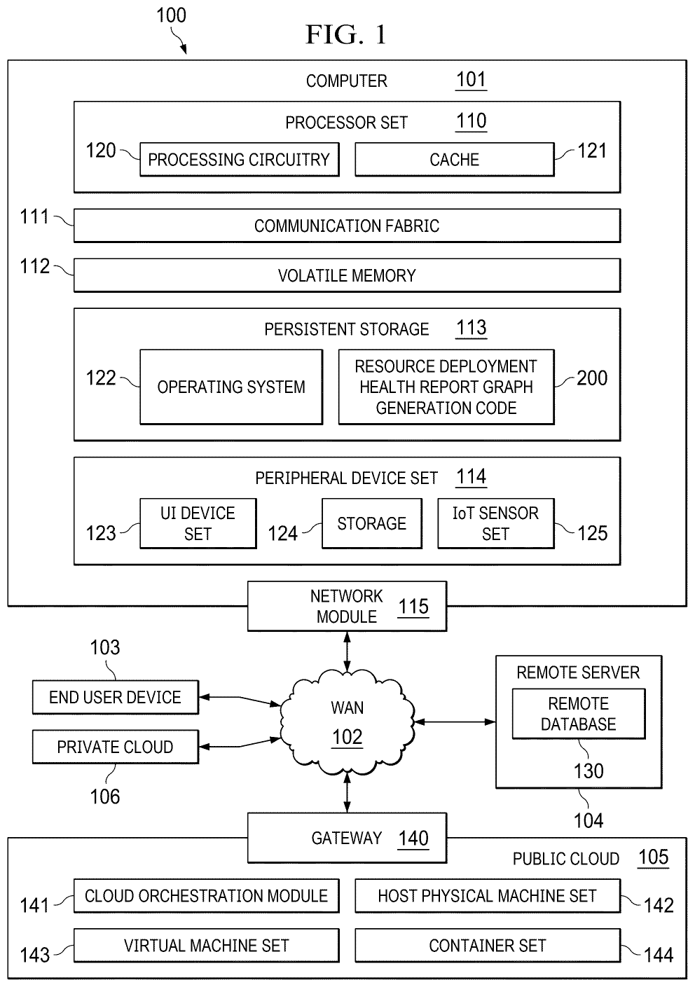

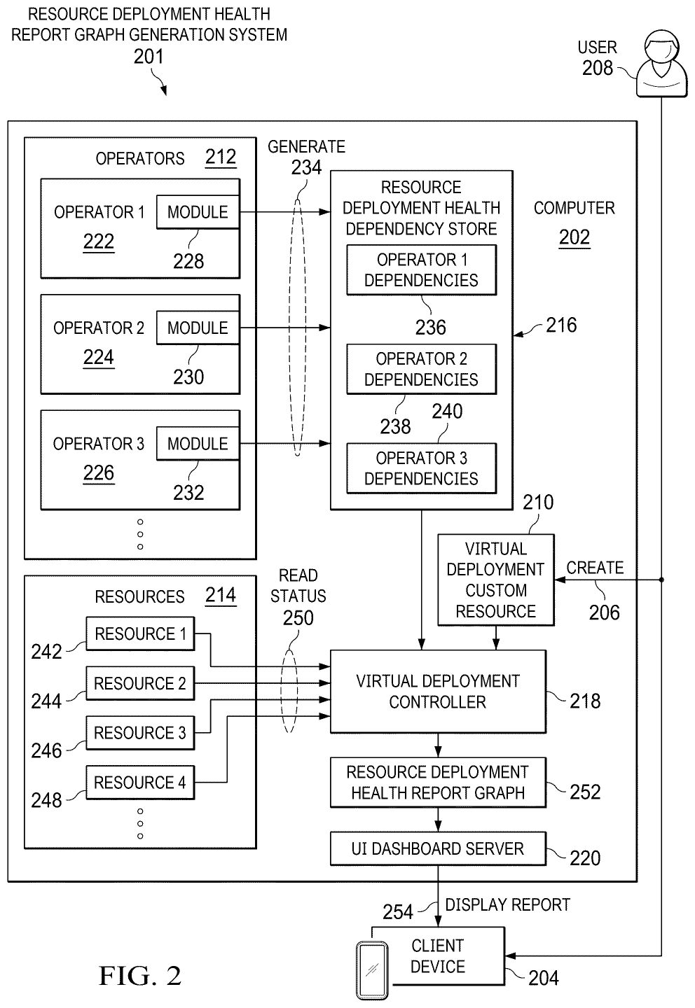

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of a container-based environment for the execution of at least some of the computer code involved in performing the inventive methods of illustrative embodiments, such as resource deployment health report graph generation code 200. For example, resource deployment health report graph generation code 200 identifies and indicates the status (e.g., ready, not ready, missing, should not exist, or the like) of each resource (e.g., application workload) of a particular virtual deployment corresponding to the container-based environment using a resource deployment health report graph, which resource deployment health report graph generation code 200 generates based on a resource deployment health dependency graph that identifies all the resource dependencies before the topology of the container-based environment is connected. In other words, resource deployment health report graph generation code 200 does not need to have real connections between resources to identify the status of each resource and any corresponding resource dependencies.

In addition to resource deployment health report graph generation code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and resource deployment health report graph generation code 200, as identified above), peripheral device set 114 (including user interface (UI) device set 123, storage 124, and Internet of Things (IoT) sensor set 125), and network module 115. Computer 101 can be, for example, a controller node in the container-based environment. Remote server 104 includes remote database 130. Public cloud 105 includes gateway 140, cloud orchestration module 141, host physical machine set 142, virtual machine set 143, and container set 144.

Computer 101 may take the form of a server computer, mainframe computer, quantum computer, desktop computer, laptop computer, tablet computer or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in resource deployment health report graph generation code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a system administrator, deployment developer, deployer, or the like who utilizes the resource deployment health report graph generation services provided by computer 101), and may take any of the forms discussed above in connection with computer 101. EUD 103 typically receives helpful and useful data from the operations of computer 101. For example, in a hypothetical case where computer 101 is designed to provide a resource deployment health report graph to the end user, this resource deployment health report graph would typically be communicated from network module 115 of computer 101 through WAN 102 to EUD 103. In this way, EUD 103 can display, or otherwise present, the resource deployment health report graph to the end user. In some embodiments, EUD 103 may be a client device, such as a thin client, heavy client, mainframe computer, desktop computer, laptop computer, tablet computer, smart phone, smart television, smart glasses, virtual reality device, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a resource deployment health report graph based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In container-based environments, such as, for example, Kubernetes, program developers can split applications into several resources (e.g., different workloads). Each resource is composed of different components and each component runs on a single container or multiple containers. However, complex dependencies exist between the resources, such as, for example, replica sets, service accounts, secrets, custom resource definitions, deployments, and the like, which can lead to issues in a container-based environment.

An operator in a container-based environment is an application-specific controller that extends the functionality of an API server in a container-based environment to generate, configure, and manage instances of complex applications on behalf of a user of the container-based environment. Current container-based environments include owner reference relationships, but do not include business logic dependencies. For example, when a container-based environment is deployed, issues can occur, such as, for example, sometimes dependency resources do not exist, sometimes dependency resources are not ready, and the like. A dependency resource is a resource that another resource (i.e., a dependent resource) depends on to run or perform its corresponding service or task.

For new a program developer who is not familiar with the entire software project, when a problem occurs with a resource during environment deployment, the new program developer may not know, for example, which code to start debugging from, which log to inspect, or the like. For a new customer who is using the software product for the first few times, when the environment deployment is unsuccessful, the new customer is unable to do anything other than wait for technical support for help. These types of issues occur when the software product is large and several program developers are responsible for developing different components of the application, when the macro business logic association diagram and the macro component dependency diagram are missing, or when the dependencies between resources are complex and no clear correlation between resources exists. As a result, when something goes wrong during environment deployment, it is difficult for new program developers and new customers to locate and solve the root problem.

Illustrative embodiments diagnose the resource deployment health in a container-based environment by generating a resource deployment health dependency graph, which shows the status (e.g., ready, not-ready, missing, or should-not-exist) of each resource in the container-based environment for an initial deployment, to assist a deployer (e.g., system administrator or the like) to understand the deployment health status of each resource. Illustrative embodiments utilize a set of new tasks, which identifies resource internal dependencies, resource external dependencies, and resource deployment preconditions, to determine the status of each resource during resource deployment in the container-based environment.

Illustrative embodiments perform resource status checks. For example, illustrative embodiments perform native resource status checks using, for example, “status.readyReplicas” for a virtual deployment. In addition, illustrative embodiments can extend resource health checks using expressions, such as, for example, “zen-service-name.status.progress==100%”. Further, illustrative embodiments perform health checks of external dependency resources using, for example, built-in scripts, custom scripts, and the like.

Illustrative embodiments utilize a resource deployment health dependency module to parse the set of new tasks to identify each dependency of each particular resource corresponding to each operator in the container-based environment and then aggregate the resource dependencies of each operator. The resource deployment health dependency module, which is located in each respective operator, stores each identified resource dependency corresponding to each particular operator in a resource deployment health dependency store.

Illustrative embodiments also utilize a virtual deployment custom resource to represent different virtual deployments for a specific target system. The deployer creates a specific custom virtual deployment according to an actual or real deployment. In addition, the deployer can create multiple virtual deployments based on multiple actual deployments.

Illustrative embodiments utilize a virtual deployment controller to analyze a file (e.g., a YAML file) stored in a configuration map, which contains the definition for the resource deployment health dependency graph, analyze resource dependencies contained in the resource deployment health dependency store, and analyze a specific virtual deployment custom resource to generate the resource deployment health dependency graph. The resource deployment health dependency graph represents the relationships between resources, dependencies of each respective resource, and any deployment preconditions corresponding to a particular resource.

The virtual deployment controller also generates a resource deployment health report graph for each specific virtual deployment based on the resource deployment health dependency graph stored in the configuration map for that particular virtual deployment. Illustrative embodiments utilize a user interface (UI) dashboard server to display the generated resource deployment health report graph to a user (e.g., the deployer) showing the status of each resource in that particular virtual deployment, along with all of the resource dependency relationships. For example, if a dependency resource on which another resource depends should exist in the environment, but does not, then illustrative embodiments mark that dependency resource on which the other resource depends as missing in the resource deployment health report graph. As a result, by illustrative embodiments generating and displaying the resource deployment health report graph, illustrative embodiments can help deployment developers to debug a virtual deployment and customers to understand the application logic. However, it should be noted that illustrative embodiments can automatically implement a virtual deployment in the container-based environment in response to illustrative embodiments determining that all resources and their corresponding dependency resources are marked as ready in the resource deployment health report graph for that particular virtual deployment.

Illustrative embodiments allow a deployment developer to define resource deployment dependency rules in addition to existing deployment business logic. Illustrative embodiments automatically collect the resource deployment dependency rules to generate the resource deployment health dependency graph for each specific virtual deployment in the container-based environment. Further, illustrative embodiments can automatically generate UI dashboards showing resource deployment health report graphs for multiple virtual deployments in a single container-based environment cluster.

Thus, illustrative embodiments provide one or more technical solutions that overcome a technical problem with an inability of current container-based environments to identify all resource dependencies and the status of each particular resource and corresponding dependency resource prior to the topology of a container-based environment being connected. As a result, these one or more technical solutions provide a technical effect and practical application in the field of container-based environments.

With reference now to FIG. 2, a diagram illustrating an example of a resource deployment health report graph generation system is depicted in accordance with an illustrative embodiment. Resource deployment health report graph generation system 201 may be implemented in a computing environment, such as computing environment 100 in FIG. 1. Resource deployment health report graph generation system 201 is a system of hardware and software components for generating a resource deployment health report graph corresponding to a specific virtual deployment in a container-based environment.

In this example, resource deployment health report graph generation system 201 includes computer 202 and client device 204. Computer 202 can be, for example, computer 101 in FIG. 1. client device 204 can be, for example, EUD 103 in FIG. 1. However, it should be noted that resource deployment health report graph generation system 201 is intended as an example only and not as a limitation on illustrative embodiments. For example, resource deployment health report graph generation system 201 can include any number of computers, client devices, and other devices and components not shown.

At 206, user 208 (e.g., a system administrator, deployment developer, deployment tester, deployer, or the like) creates virtual deployment custom resource 210, which is based on an actual or real deployment, and inputs virtual deployment custom resource 210 in computer 202 using client device 204. Virtual deployment custom resource 210 is a specific custom virtual deployment for the container-based environment. In this example, computer 202 includes operators 212, resources 214, resource deployment health dependency store 216, virtual deployment controller 218, and UI dashboard server 220. However, computer 202 is intended as an example only and can include any number of other components not shown.

In this example, operators 212 include operator 1 222, operator 2 224, and operator 3 226. Operator 1 222 contains resource deployment health dependency module 228, operator 2 224 contains resource deployment health dependency module 230, and operator 3 226 contains resource deployment health dependency module 232.

At 234, operator 1 222 utilizes resource deployment health dependency module 228 to generate operator 1 resource dependencies 236, operator 2 224 utilizes resource deployment health dependency module 230 to generate operator 2 resource dependencies 238, and operator 3 226 utilizes resource deployment health dependency module 232 to generate operator 3 resource dependencies 240. Operator 1 resource dependencies 236, operator 2 resource dependencies 238, and operator 3 resource dependencies 240 represent dependencies of resources corresponding to virtual deployment custom resource 210. Resource deployment health dependency module 228, resource deployment health dependency module 230, and resource deployment health dependency module 232 store operator 1 resource dependencies 236, operator 2 resource dependencies 238, and operator 3 resource dependencies 240, respectively, in resource deployment health dependency store 216.

In this example, resources include resource 1 242, resource 2 244, resource 3 246, and resource 4 248. Resource 1 242, resource 2 244, resource 3 246, and resource 4 248 can represent different workloads corresponding to one or more containerized applications. At 250, virtual deployment controller 218 reads the status of resource 1 242, resource 2 244, resource 3 246, and resource 4 248 that virtual deployment controller 218 retrieved from an API server. In addition, virtual deployment controller 218 analyzes virtual deployment custom resource 210 and analyzes operator 1 resource dependencies 236, operator 2 resource dependencies 238, and operator 3 resource dependencies 240 corresponding to virtual deployment custom resource 210.

Based on reading the status of resource 1 242, resource 2 244, resource 3 246, and resource 4 248 and analyzing virtual deployment custom resource 210 and operator 1 resource dependencies 236, operator 2 resource dependencies 238, and operator 3 resource dependencies 240 corresponding to virtual deployment custom resource 210, virtual deployment controller 218 generates resource deployment health report graph 252. Resource deployment health report graph 252 shows all the resources dependencies and the status of each resource and dependency resource corresponding to virtual deployment custom resource 210.

Virtual deployment controller 218 inputs resource deployment health report graph 252 in UI dashboard server 220. At 254, UI dashboard server 220 reads resource deployment health report graph 252 and displays resource deployment health report graph 252 in client device 204 for user 208 to review and then resolve any issue with unhealthy resources in the actual deployment, if necessary.

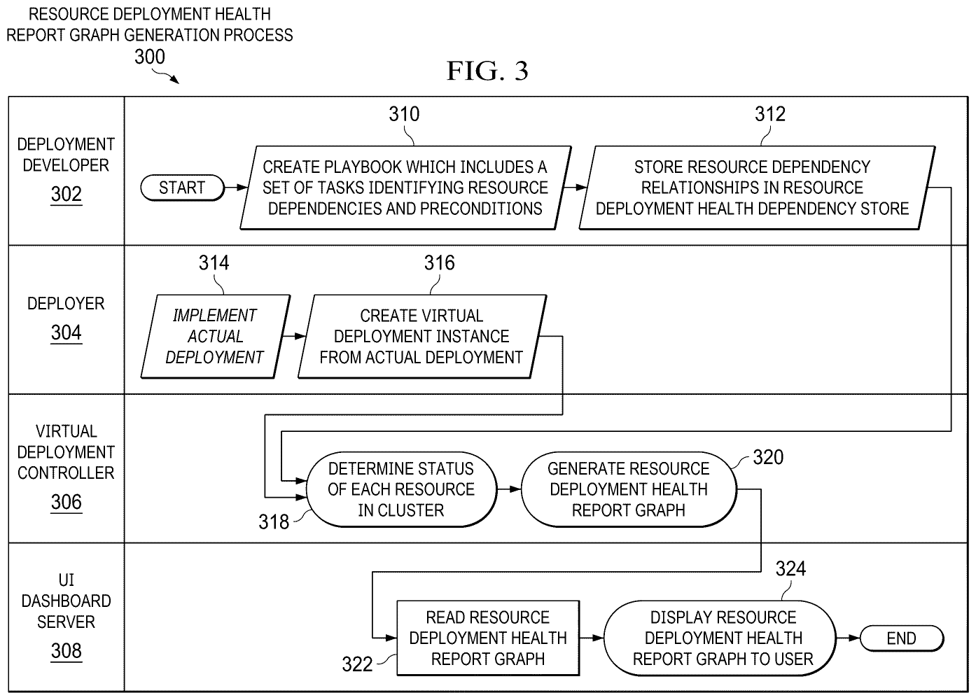

With reference now to FIG. 3, a diagram illustrating an example of a resource deployment health report graph generation process is depicted in accordance with an illustrative embodiment. Resource deployment health report graph generation process 300 is implemented in a computer, such as computer 101 in FIG. 1 or computer 202 in FIG. 2.

In this example, resource deployment health report graph generation process 300 includes deployment developer 302, deployer 304, virtual deployment controller 306, and UI dashboard server 308. Deployment developer 302 and deployer 304 are users, such as user 208 in FIG. 2. Virtual deployment controller 306 and UI dashboard server 308 can be, for example, virtual deployment controller 218 and UI dashboard server 220 in FIG. 2.

At 310, deployment developer 302 creates a playbook which includes a set of tasks identifying resource dependencies and resource deployment preconditions for a particular virtual deployment. At 312, the resource dependency relationships and resource deployment preconditions are stored in a resource deployment health dependency store, such as resource deployment health dependency store 216 in FIG. 2.

At 314, deployer 304 implements an actual deployment for a container-based environment. At 316, deployer 304 creates a virtual deployment instance from the actual deployment.

At 318, virtual deployment controller 306 determines a status of each resource in the cluster of the container-based environment by analyzing the virtual deployment instance, the resource dependency relationships, and the resource deployment preconditions. At 320, virtual deployment controller 306 generates a resource deployment health report graph, such as resource deployment health report graph 252 in FIG. 2, based on the status of each respective resource in the cluster and the resource dependency relationships.

At 322, UI dashboard server 308 reads the resource deployment health report graph. At 324, UI dashboard server 308 displays the resource deployment health report graph to the user (e.g., deployment developer 302, deployer 304, or the like).

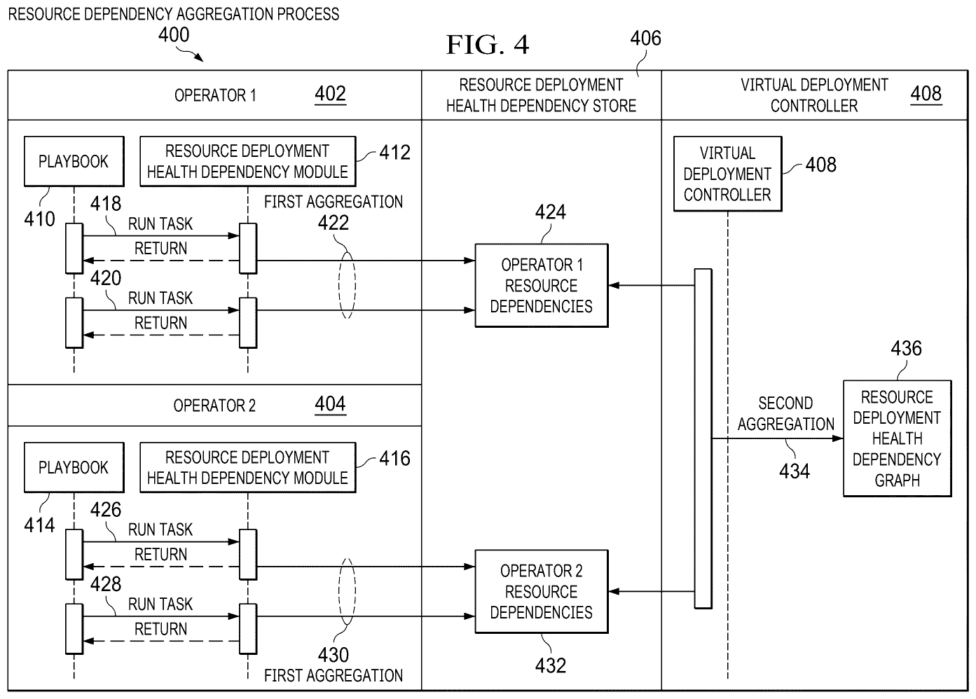

With reference now to FIG. 4, a diagram illustrating an example of a resource dependency aggregation process is depicted in accordance with an illustrative embodiment. Resource dependency aggregation process 400 is implemented in a computer, such as computer 101 in FIG. 1 or computer 202 in FIG. 2.

In this example, resource dependency aggregation process 400 includes operator 1 402, operator 2 404, resource deployment health dependency store 406, and virtual deployment controller 408. Operator 1 402, operator 2 404, resource deployment health dependency store 406, and virtual deployment controller 408 can be, for example, operator 1 222, operator 2 224, resource deployment health dependency store 216, and virtual deployment controller 218 in FIG. 2.

Operator 1 402 contains playbook 410 and resource deployment health dependency module 412. Playbook 410 includes a set of tasks that is automatically executed in a predefined order. Resource deployment health dependency module 412 executes each of the tasks included in playbook 410. Similarly, operator 2 404 contains playbook 414 and resource deployment health dependency module 416. Playbook 414 includes another set of tasks that is automatically executed in a predefined order. Resource deployment health dependency module 416 executes each of the tasks included in playbook 414.

At 418, resource deployment health dependency module 412 runs a first task in playbook 410; at 420, resource deployment health dependency module 412 runs a second task in playbook 410; and so on until all tasks in playbook 410 have run. At 422, resource deployment health dependency module 412 performs a first aggregation of resource dependencies identified by running the tasks to form operator 1 resource dependencies 424, which resource deployment health dependency module 412 stores in resource deployment health dependency store 406.

Similarly, at 426, resource deployment health dependency module 416 runs a first task in playbook 414; at 428, resource deployment health dependency module 416 runs a second task in playbook 414; and so on until all tasks in playbook 414 have run. At 430, resource deployment health dependency module 416 performs a first aggregation of resource dependencies identified by running the tasks to form operator 2 resource dependencies 432, which resource deployment health dependency module 416 stores in resource deployment health dependency store 406.

At 434, virtual deployment controller 408 retrieves operator 1 resource dependencies 424 and operator 2 resource dependencies 432 from resource deployment health dependency store 406 and performs a second aggregation of the resource dependencies. Then, virtual deployment controller 408 inputs all of the resource dependencies in resource deployment health dependency graph 436.

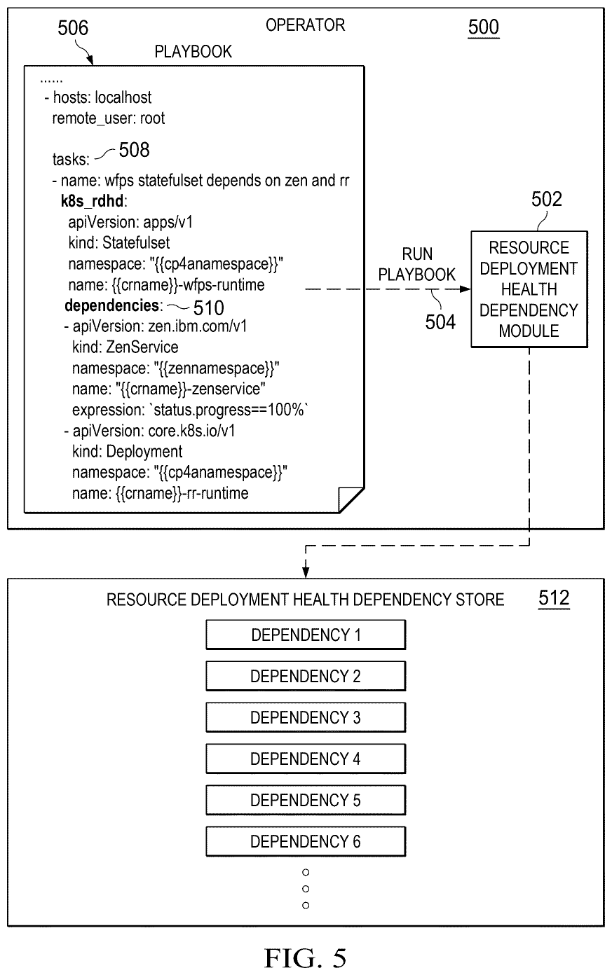

With reference now to FIG. 5, a diagram illustrating an example of an operator is depicted in accordance with an illustrative embodiment. Operator 500 is implemented in a computer, such as computer 101 in FIG. 1 or computer 202 in FIG. 2.

Operator 500 includes resource deployment health dependency module 502. Resource deployment health dependency module 502 can be, for example, resource deployment health dependency module 228 in FIG. 2 or resource deployment health dependency module 412 in FIG. 4. At 504, operator 500 utilizes resource deployment health dependency module 502 to run playbook 506 and parse tasks 508 in playbook 506 to identify resource dependencies 510. Playbook 506 can be, for example, playbook 410 in FIG. 4. Resource deployment health dependency module 502 stores the identified resource dependencies in resource deployment health dependency store 512, such as resource dependencies in resource deployment health dependency store 216 in FIG. 2. It should be noted that the deployment developer creates the resource dependency rules for identifying the resource dependencies.

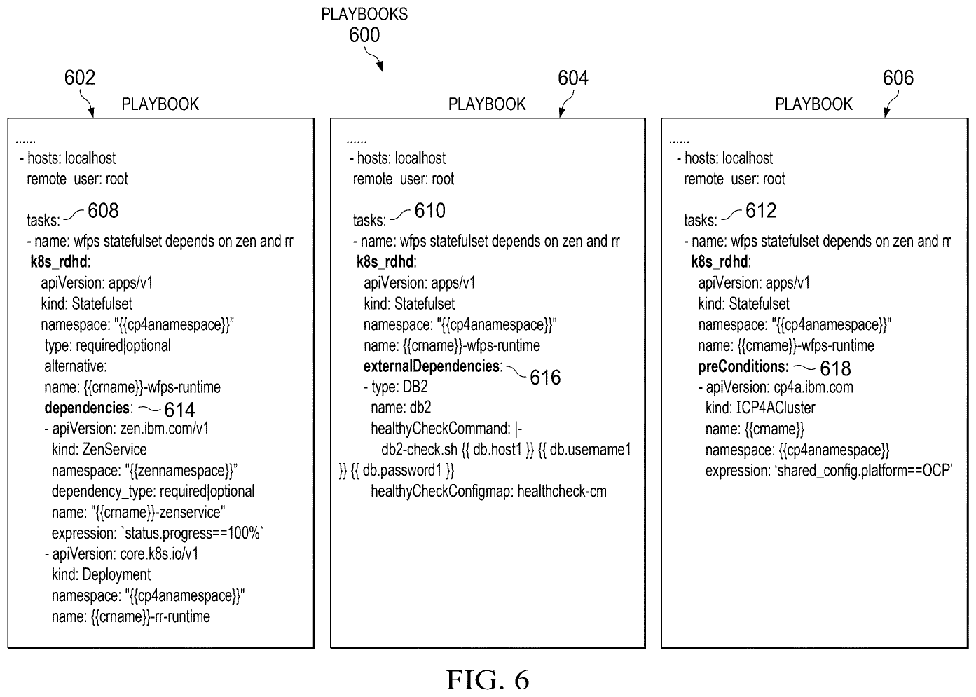

With reference now to FIG. 6, a diagram illustrating an example of playbooks is depicted in accordance with an illustrative embodiment. In this example, playbooks 600 include playbook 602, playbook 604, and playbook 606. Playbooks 600 can be implemented in an operator, such as operator 500 in FIG. 5. Playbook 602, playbook 604, and playbook 606 can be, for example, YAML files or the like. Playbook 602 includes tasks 608, playbook 604 includes tasks 610, and playbook 606 includes tasks 612. Each of tasks 608, tasks 610, and tasks 612 represents a set of tasks. Illustrative embodiments utilize a resource deployment health dependency module (e.g., resource deployment health dependency module 502 in FIG. 5) to extract dependencies 614, external dependencies 616, and preconditions 618 from tasks 608, tasks 610, and tasks 612, respectively.

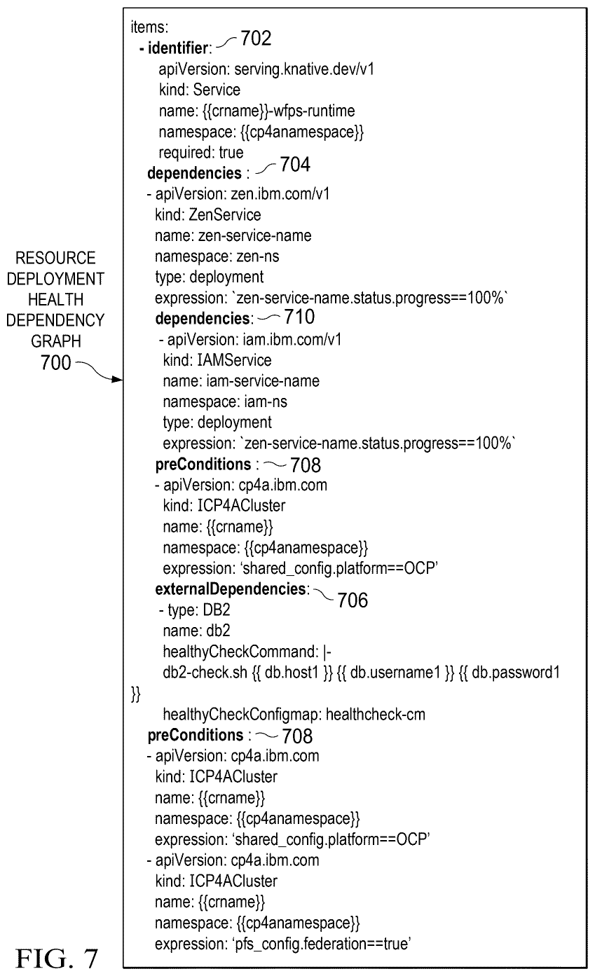

With reference now to FIG. 7, a diagram illustrating an example of a resource deployment health dependency graph is depicted in accordance with an illustrative embodiment. Resource deployment health dependency graph 700 is implemented in a computer 101 in FIG. 1 or computer 202 in FIG. 2. The computer utilizes a virtual deployment controller, such as virtual deployment controller 408 in FIG. 4, to generate resource deployment health dependency graph 700.

Illustrative embodiments store resource deployment health dependency graph 700 in, for example, a YAML file of a configuration map. Resource deployment health dependency graph 700 includes identifier 702, dependencies 704, external dependencies 706, and preconditions 708. Identifier 702 uniquely identifies a particular resource in the container-based environment by, for example, group, version, and kind. Dependencies 704 identify a set of dependency resources that a particular resource depends on to run or perform its corresponding service or task. It should be noted that a dependency resource can have its own set of dependency resources, such as dependencies 710. External dependencies 706 identify a set of external dependency resources that the particular resource also depends on to run. Preconditions 708 identify a set of prerequisites or requirements that determine whether that particular resource should be deployed or not in a particular virtual deployment of the container-based environment. Illustrative embodiments utilize the virtual deployment controller to aggregate dependencies stored in a resource deployment health dependency store, such as resource deployment health dependency store 216 in FIG. 2, to generate resource deployment health dependency graph 700 for that particular virtual deployment.

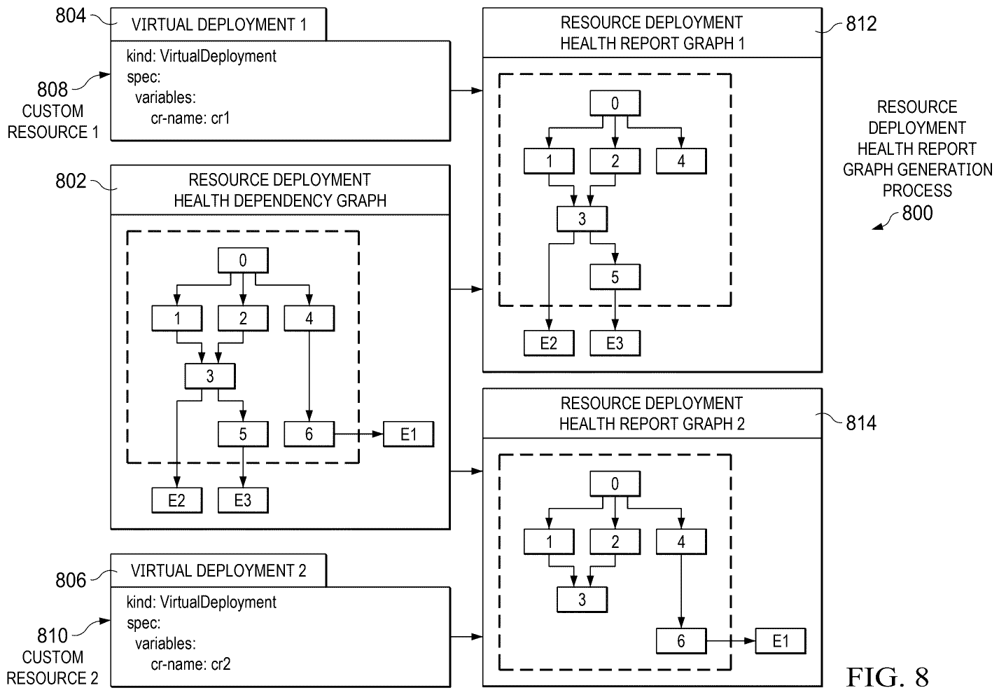

With reference now to FIG. 8, a diagram illustrating an example of a resource deployment health report graph generation process is depicted in accordance with an illustrative embodiment. Resource deployment health report graph generation process 800 is implemented in a computer 101 in FIG. 1 or computer 202 in FIG. 2.

Illustrative embodiments generate resource deployment health dependency graph 802 when associated with a specific virtual deployment, such as virtual deployment 1 804 or virtual deployment 2 806. Virtual deployment 1 804 and virtual deployment 2 806 are based on custom resource 1 808 and custom resource 2 810, respectively. Illustrative embodiments generate resource deployment health graph 1 812 based on resource deployment health dependency graph 802 and virtual deployment 1 804. Illustrative embodiments generate resource deployment health graph 2 814 based on resource deployment health dependency graph 802 and virtual deployment 2 806.

A virtual deployment is a custom resource definition in the container-based environment with which the deployer can create a custom virtual deployment according to an actual or real deployment in the container-based environment. Multiple virtual deployments of the same kind can share a single resource deployment health dependency graph, such as resource deployment health dependency graph 802. Each virtual deployment should refer to one resource deployment health dependency graph associated with, for example, specification variables that define the values of variables referenced by the definition corresponding to that resource deployment health dependency graph contained in a configuration map, a specification secure variable secret name that refers to a secret storing the value of confidential variables referenced by the definition corresponding to that resource deployment health dependency graph contained in a configuration map, and the like.

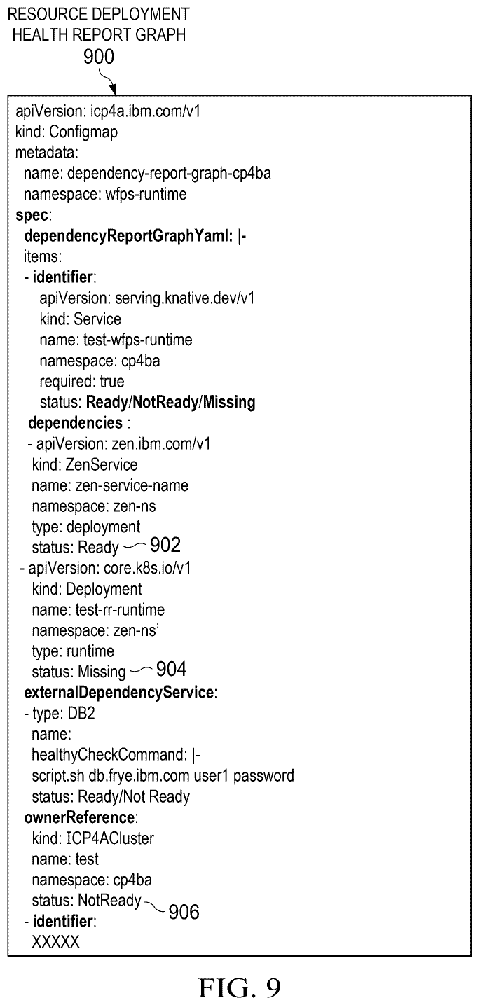

With reference now to FIG. 9, a diagram illustrating an example of a resource deployment health report graph is depicted in accordance with an illustrative embodiment. Resource deployment health report graph 900 is implemented in a computer 101 in FIG. 1 or computer 202 in FIG. 2. The computer utilizes a virtual deployment controller, such as virtual deployment controller 408 in FIG. 4, to generate resource deployment health report graph 900.

Illustrative embodiments store resource deployment health report graph 900 in, for example, a YAML file of a configuration map. Illustrative embodiments generate resource deployment health report graph 900 based on a resource deployment health dependency graph, such as, for example, resource deployment health dependency graph 802 in FIG. 8. Illustrative embodiments determine whether a resource should appear in resource deployment health report graph 900 based on the resource deployment preconditions in the resource deployment health dependency graph, such as, for example, preconditions 708 in resource deployment health dependency graph 700 in FIG. 7. The status of a resource in resource deployment health report graph 900 can be one of ready, missing, and not ready, such as ready 902, missing 904, and not ready 906. Ready 902 indicates that the resource is available in a ready state, and all its dependency resources are in a ready state as well. Missing 904 indicates that the resource does not currently exist in the container-based environment. Not ready 906 indicates that either the resource itself is not in a ready state or the dependency resource on which the resource depends is not in a ready state. A UI dashboard server (e.g., UI dashboard server 220 in FIG. 2 or UI dashboard server 308 in FIG. 3) displays resource deployment health report graph 900 to a user showing the deployment status of each particular resource.

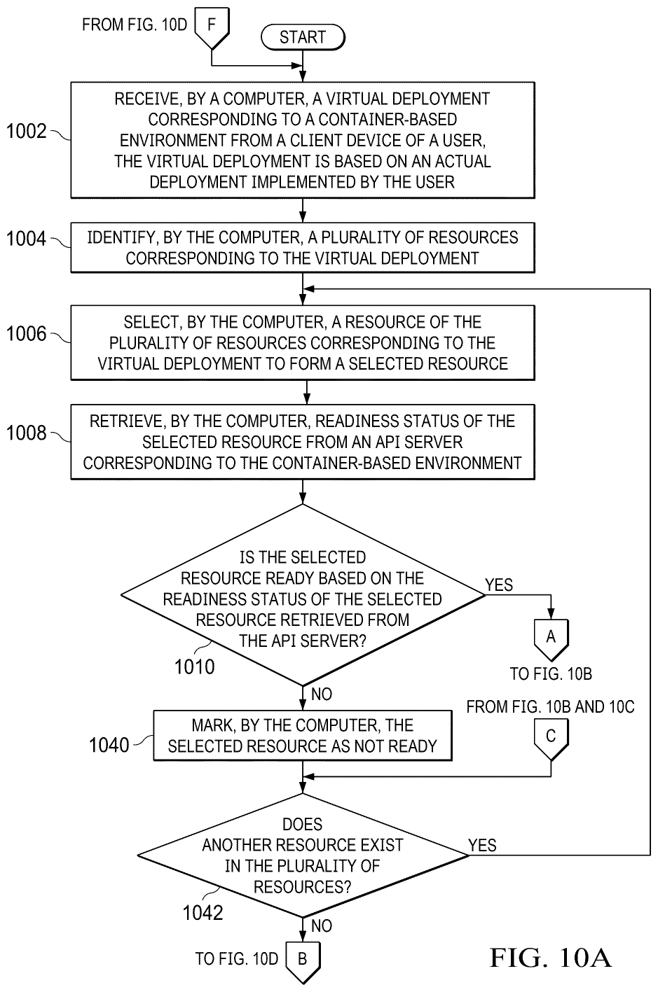

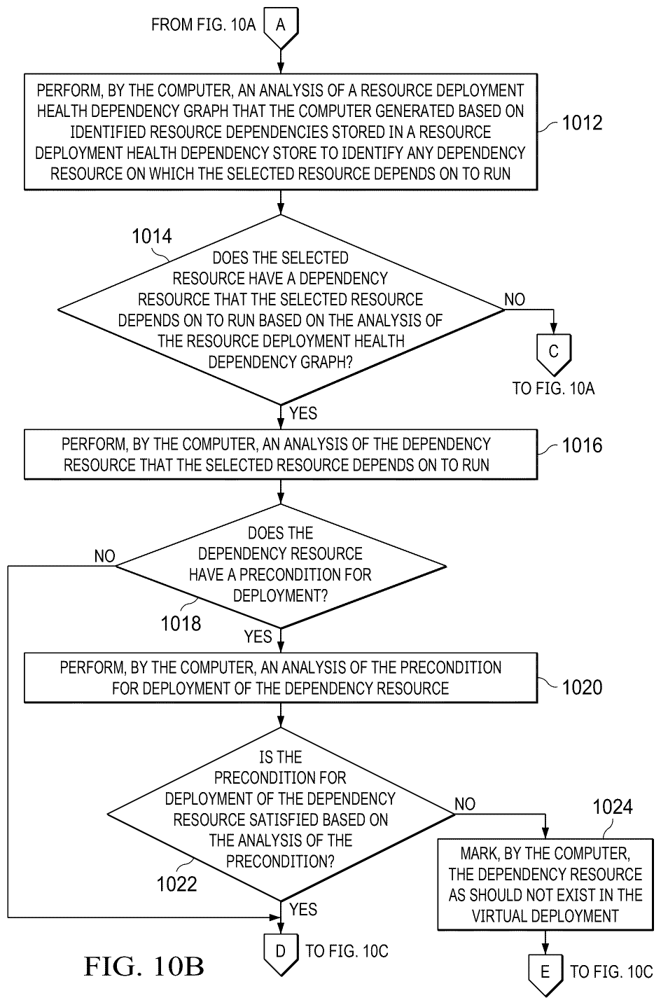

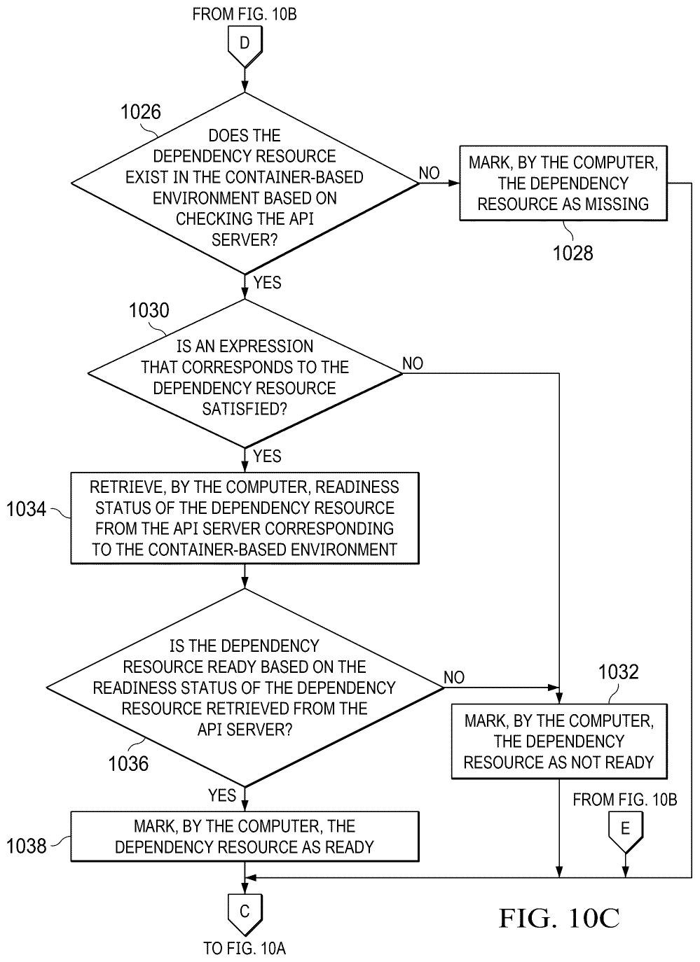

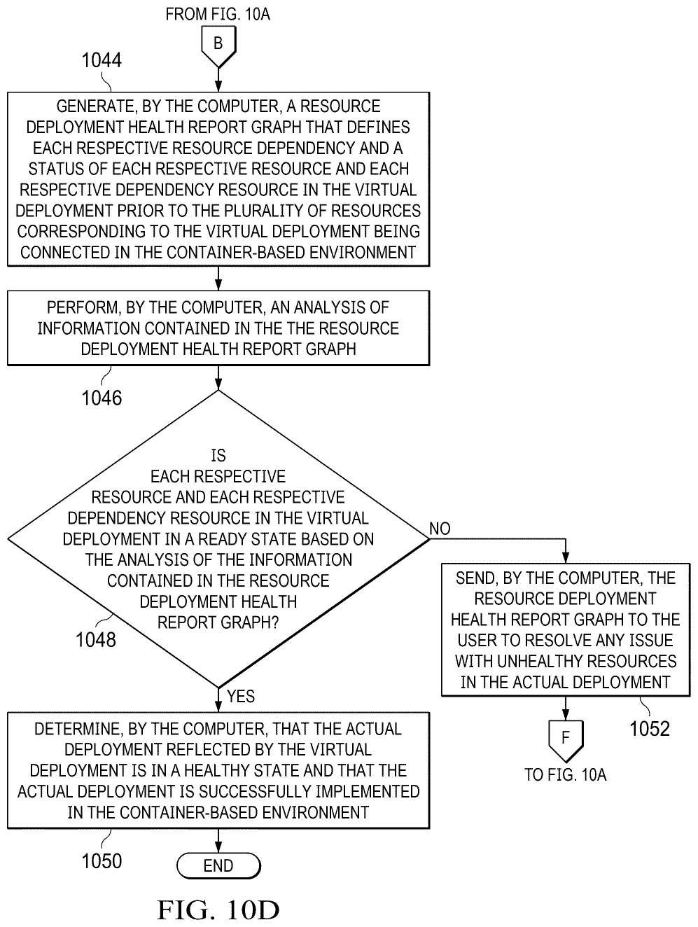

With reference now to FIGS. 10A-10D, a flowchart illustrating a process for generating a resource deployment health report graph corresponding to a specific virtual deployment is shown in accordance with an illustrative embodiment. The process shown in FIGS. 10A-10D may be implemented in a computer, such as, for example, computer 101 in FIG. 1 or computer 202 in FIG. 2. For example, the process shown in FIGS. 10A-10D may be implemented by resource deployment health report graph generation code 200 in FIG. 1.

The process begins when the computer receives a virtual deployment corresponding to a container-based environment from a client device of a user (step 1002). The virtual deployment is based on an actual deployment implemented by the user. In response to the computer receiving the virtual deployment, the computer identifies a plurality of resources corresponding to the virtual deployment (step 1004).

The computer selects a resource of the plurality of resources corresponding to the virtual deployment to form a selected resource (step 1006). The computer retrieves readiness status of the selected resource from an API server corresponding to the container-based environment (step 1008). It should be noted that the API server can be located locally in the computer or remotely in another node of the container-based environment.

The computer makes a determination as to whether the selected resource is ready based on the readiness status of the selected resource retrieved from the API server (step 1010). If the computer determines that the selected resource is ready based on the readiness status of the selected resource retrieved from the API server, yes output of step 1010, then the computer performs an analysis of a resource deployment health dependency graph, which the computer generated based on identified resource dependencies stored in a resource deployment health dependency store, to identify any dependency resource on which the selected resource depends on to run (step 1012).

The computer makes a determination as to whether the selected resource has a dependency resource that the selected resource depends on to run based on the analysis of the resource deployment health dependency graph (step 1014). If the computer determines that the selected resource does not have a dependency resource that the selected resource depends on to run based on the analysis of the resource deployment health dependency graph, no output of step 1014, then the process proceeds to step 1042.

If the computer determines that the selected resource does have a dependency resource that the selected resource depends on to run based on the analysis of the resource deployment health dependency graph, yes output of step 1014, then the computer performs an analysis of the dependency resource that the selected resource depends on to run (step 1016). The computer makes a determination as to whether the dependency resource has a precondition for deployment in the virtual deployment of the container-based environment based on the analysis of the dependency resource (step 1018).

If the computer determines that the dependency resource does have a precondition for deployment in the virtual deployment of the container-based environment based on the analysis of the dependency resource, yes output of step 1018, then the computer performs an analysis of the precondition for deployment of the dependency resource (step 1020). The computer makes a determination as to whether the precondition for deployment of the dependency resource is satisfied based on the analysis of the precondition (step 1022).

If the computer determines that the precondition for deployment of the dependency resource is satisfied based on the analysis of the precondition, yes output of step 1022, then the process proceeds to step 1026. If the computer determines that the precondition for deployment of the dependency resource is not satisfied based on the analysis of the precondition, no output of step 1022, then the computer marks the dependency resource as should not exist in the virtual deployment (step 1024). Thereafter, the process proceeds to step 1042.

Returning again to step 1018, if the computer determines that the dependency resource does not have a precondition for deployment in the virtual deployment of the container-based environment based on the analysis of the dependency resource, no output of step 1018, then the computer makes a determination as to whether the dependency resource exists in the container-based environment based on checking the API server (step 1026). If the computer determines that the dependency resource does not exist in the container-based environment based on checking the API server, no output of step 1026, then the computer marks the dependency resource as missing (step 1028). Thereafter, the process proceeds to step 1042. If the computer determines that the dependency resource does exist in the container-based environment based on checking API server, yes output of step 1026, then the computer makes a determination as to whether an expression that corresponds to the dependency resource in the resource deployment health dependency graph is satisfied (step 1030).

If the computer determines that an expression that corresponds to the dependency resource in the resource deployment health dependency graph is not satisfied, no output of step 1030, then the computer marks the dependency resource as not ready (step 1032). Thereafter, the process proceeds to step 1042. If the computer determines that an expression that corresponds to the dependency resource in the resource deployment health dependency graph is satisfied, yes output of step 1030, then the computer retrieves readiness status of the dependency resource from the API server corresponding to the container-based environment (step 1034).

The computer makes a determination as to whether the dependency resource is ready based on the readiness status of the dependency resource retrieved from the API server (step 1036). If the computer determines that the dependency resource is not ready based on the readiness status of the dependency resource retrieved from the API server, no output of step 1036, then the process returns to step 1032 where the computer marks the dependency resource as not ready. If the computer determines that the dependency resource is ready based on the readiness status of the dependency resource retrieved from the API server, yes output of step 1036, then the computer marks the dependency resource as ready (step 1038). Thereafter, the process proceeds to step 1042.

Returning again to step 1010, if the computer determines that the selected resource is not ready based on the readiness status of the selected resource retrieved from the API server, no output of step 1010, then the computer marks the selected resource as not ready (step 1040). Afterward, the computer makes a determination as to whether another resource exists in the plurality of resources (step 1042).

If the computer determines that another resource does exist in the plurality of resources, yes output of step 1042, then the process returns to step 1006 where the computer selects another resource from the plurality of resources corresponding to the virtual deployment. If the computer determines that another resource does not exist in the plurality of resources, no output of step 1042, then the computer generates a resource deployment health report graph that defines each respective resource dependency and a status of each respective resource and each respective dependency resource in the virtual deployment prior to the plurality of resources corresponding to the virtual deployment being connected in the container-based environment (step 1044).

The computer performs an analysis of information contained in the resource deployment health report graph (step 1046). The computer makes a determination as to whether each respective resource and each respective dependency resource in the virtual deployment is in a ready state based on the analysis of the information contained in the resource deployment health report graph (step 1048). If the computer determines that each respective resource and each respective dependency resource in the virtual deployment is in a ready state based on the analysis of the information contained in the resource deployment health report graph, yes output of step 1048, then the computer determines that the actual deployment reflected by the virtual deployment is in a healthy state and that the actual deployment is successfully implemented in the container-based environment (step 1050). Thereafter, the process terminates. If the computer determines that each respective resource and each respective dependency resource in the virtual deployment is not in a ready state based on the analysis of the information contained in the resource deployment health report graph, no output of step 1048, then the computer sends the resource deployment health report graph to the user to resolve any issue with unhealthy resources in the actual deployment (step 1052). Thereafter, the process returns to step 1002 where the computer continues to check the health state of the virtual deployment corresponding to the container-based environment received from the client device of the user.

Thus, illustrative embodiments of the present disclosure provide a computer-implemented method, computer system, and computer program product for generating resource deployment health report graphs corresponding to specific virtual deployments in container-based environments. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating resource deployment health report graphs for specific virtual deployments, the computer-implemented method comprising:
generating, by a computer, a resource deployment health report graph that defines each respective resource dependency and a status of each respective resource and each respective dependency resource in a virtual deployment of a container-based environment prior to a plurality of resources corresponding to the virtual deployment being connected in the container-based environment;
performing, by the computer, an analysis of information contained in the resource deployment health report graph;
determining, by the computer, whether each respective resource and each respective dependency resource in the virtual deployment of the container-based environment is in a ready state based on the analysis of the information contained in the resource deployment health report graph; and
responsive to the computer determining that each respective resource and each respective dependency resource in the virtual deployment of the container-based environment is in a ready state based on the analysis of the information contained in the resource deployment health report graph, determining, by the computer, that an actual deployment reflected by the virtual deployment is in a healthy state and that the actual deployment is successfully implemented in the container-based environment.

2. The computer-implemented method of claim 1, further comprising:
responsive to the computer determining that each respective resource and each respective dependency resource in the virtual deployment is not in a ready state based on the analysis of the information contained in the resource deployment health report graph, sending, by the computer, the resource deployment health report graph to a user to resolve any issue with unhealthy resources in the actual deployment.

3. The computer-implemented method of claim 1, further comprising:
receiving, by the computer, the virtual deployment corresponding to the container-based environment from a client device of a user, the virtual deployment is based on the actual deployment implemented by the user;
identifying, by the computer, the plurality of resources corresponding to the virtual deployment in response to the computer receiving the virtual deployment;
selecting, by the computer, a resource of the plurality of resources corresponding to the virtual deployment to form a selected resource; and
retrieving, by the computer, readiness status of the selected resource from an application programming interface (API) server.

4. The computer-implemented method of claim 3, further comprising:
determining, by the computer, whether the selected resource is ready based on the readiness status of the selected resource retrieved from the API server;
responsive to the computer determining that the selected resource is ready based on the readiness status of the selected resource retrieved from the API server, performing, by the computer, an analysis of a resource deployment health dependency graph that the computer generated based on identified resource dependencies stored in a resource deployment health dependency store to identify any dependency resource on which the selected resource depends on to run;
determining, by the computer, whether the selected resource has a dependency resource that the selected resource depends on to run based on the analysis of the resource deployment health dependency graph; and
responsive to the computer determining that the selected resource does have a dependency resource that the selected resource depends on to run based on the analysis of the resource deployment health dependency graph, performing, by the computer, an analysis of the dependency resource that the selected resource depends on to run.

5. The computer-implemented method of claim 4, further comprising:
determining, by the computer, whether the dependency resource has a precondition for deployment in the virtual deployment of the container-based environment based on the analysis of the dependency resource;
responsive to the computer determining that the dependency resource does have a precondition for deployment in the virtual deployment of the container-based environment based on the analysis of the dependency resource, performing, by the computer, an analysis of the precondition for deployment of the dependency resource;
determining, by the computer, whether the precondition for deployment of the dependency resource is satisfied based on the analysis of the precondition; and
responsive to the computer determining that the precondition for deployment of the dependency resource is not satisfied based on the analysis of the precondition, marking, by the computer, the dependency resource as should not exist in the virtual deployment of the container-based environment.

6. The computer-implemented method of claim 5, further comprising:
responsive to the computer determining that the dependency resource does not have a precondition for deployment in the virtual deployment of the container-based environment based on the analysis of the dependency resource, determining, by the computer, whether the dependency resource exists in the container-based environment based on checking the API server; and
responsive to the computer determining that the dependency resource does not exist in the container-based environment, marking, by the computer, the dependency resource as missing.

7. The computer-implemented method of claim 6, further comprising:
responsive to the computer determining that the dependency resource does exist in the container-based environment, determining, by the computer, whether an expression that corresponds to the dependency resource in the resource deployment health dependency graph is satisfied; and
responsive to the computer determining that the expression that corresponds to the dependency resource in the resource deployment health dependency graph is not satisfied, marking, by the computer, the dependency resource as not ready.

8. The computer-implemented method of claim 7, further comprising:
responsive to the computer determining that the expression that corresponds to the dependency resource in the resource deployment health dependency graph is satisfied, retrieving, by the computer, readiness status of the dependency resource from the API server;
determining, by the computer, whether the dependency resource is ready based on the readiness status of the dependency resource retrieved from the API server; and
responsive to the computer determining that the dependency resource is not ready based on the readiness status of the dependency resource retrieved from the API server, marking, by the computer, the dependency resource as not ready.

9. The computer-implemented method of claim 8, further comprising:
responsive to the computer determining that the dependency resource is ready based on the readiness status of the dependency resource retrieved from the API server, marking, by the computer, the dependency resource as ready;
determining, by the computer, whether another resource exists in the plurality of resources corresponding to the virtual deployment; and
responsive to the computer determining that another resource does exist in the plurality of resources corresponding to the virtual deployment, selecting, by the computer, another resource from the plurality of resources corresponding to the virtual deployment.

10. A computer system for generating resource deployment health report graphs for specific virtual deployments, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
generate a resource deployment health report graph that defines each respective resource dependency and a status of each respective resource and each respective dependency resource in a virtual deployment of a container-based environment prior to a plurality of resources corresponding to the virtual deployment being connected in the container-based environment;
perform an analysis of information contained in the resource deployment health report graph;
determine whether each respective resource and each respective dependency resource in the virtual deployment of the container-based environment is in a ready state based on the analysis of the information contained in the resource deployment health report graph; and
determine that an actual deployment reflected by the virtual deployment is in a healthy state and that the actual deployment is successfully implemented in the container-based environment in response to determining that each respective resource and each respective dependency resource in the virtual deployment of the container-based environment is in a ready state based on the analysis of the information contained in the resource deployment health report graph.

11. The computer system of claim 10, wherein the set of processors further executes the program instructions to:
send the resource deployment health report graph to a user to resolve any issue with unhealthy resources in the actual deployment in response to determining that each respective resource and each respective dependency resource in the virtual deployment is not in a ready state based on the analysis of the information contained in the resource deployment health report graph.

12. The computer system of claim 10, wherein the set of processors further executes the program instructions to:
receive the virtual deployment corresponding to the container-based environment from a client device of a user, the virtual deployment is based on the actual deployment implemented by the user;
identify the plurality of resources corresponding to the virtual deployment in response to receiving the virtual deployment;
select a resource of the plurality of resources corresponding to the virtual deployment to form a selected resource; and
retrieve readiness status of the selected resource from an application programming interface (API) server.

13. The computer system of claim 12, wherein the set of processors further executes the program instructions to:
determine whether the selected resource is ready based on the readiness status of the selected resource retrieved from the API server;
perform an analysis of a resource deployment health dependency graph that was generated based on identified resource dependencies stored in a resource deployment health dependency store to identify any dependency resource on which the selected resource depends on to run in response to determining that the selected resource is ready based on the readiness status of the selected resource retrieved from the API server;
determine whether the selected resource has a dependency resource that the selected resource depends on to run based on the analysis of the resource deployment health dependency graph; and
perform an analysis of the dependency resource that the selected resource depends on to run in response to determining that the selected resource does have a dependency resource that the selected resource depends on to run based on the analysis of the resource deployment health dependency graph.

14. The computer system of claim 13, wherein the set of processors further executes the program instructions to:
determine whether the dependency resource has a precondition for deployment in the virtual deployment of the container-based environment based on the analysis of the dependency resource;
perform an analysis of the precondition for deployment of the dependency resource in response to determining that the dependency resource does have a precondition for deployment in the virtual deployment of the container-based environment based on the analysis of the dependency resource;
determine whether the precondition for deployment of the dependency resource is satisfied based on the analysis of the precondition; and
mark the dependency resource as should not exist in the virtual deployment of the container-based environment in response to determining that the precondition for deployment of the dependency resource is not satisfied based on the analysis of the precondition.

15. A computer program product for generating resource deployment health report graphs for specific virtual deployments, the computer program product comprising a set of computer-readable storage media having program instructions collectively stored therein, the program instructions executable by a computer to cause the computer to:
generate a resource deployment health report graph that defines each respective resource dependency and a status of each respective resource and each respective dependency resource in a virtual deployment of a container-based environment prior to a plurality of resources corresponding to the virtual deployment being connected in the container-based environment;
perform an analysis of information contained in the resource deployment health report graph;
determine whether each respective resource and each respective dependency resource in the virtual deployment of the container-based environment is in a ready state based on the analysis of the information contained in the resource deployment health report graph; and
determine that an actual deployment reflected by the virtual deployment is in a healthy state and that the actual deployment is successfully implemented in the container-based environment in response to determining that each respective resource and each respective dependency resource in the virtual deployment of the container-based environment is in a ready state based on the analysis of the information contained in the resource deployment health report graph.

16. The computer program product of claim 15, wherein the program instructions further cause the computer to:
send the resource deployment health report graph to a user to resolve any issue with unhealthy resources in the actual deployment in response to determining that each respective resource and each respective dependency resource in the virtual deployment is not in a ready state based on the analysis of the information contained in the resource deployment health report graph.

17. The computer program product of claim 15, wherein the program instructions further cause the computer to:
receive the virtual deployment corresponding to the container-based environment from a client device of a user, the virtual deployment is based on the actual deployment implemented by the user;
identify the plurality of resources corresponding to the virtual deployment in response to receiving the virtual deployment;
select a resource of the plurality of resources corresponding to the virtual deployment to form a selected resource; and
retrieve readiness status of the selected resource from an application programming interface (API) server.

18. The computer program product of claim 17, wherein the program instructions further cause the computer to:
determine whether the selected resource is ready based on the readiness status of the selected resource retrieved from the API server;
perform an analysis of a resource deployment health dependency graph that was generated based on identified resource dependencies stored in a resource deployment health dependency store to identify any dependency resource on which the selected resource depends on to run in response to determining that the selected resource is ready based on the readiness status of the selected resource retrieved from the API server;
determine whether the selected resource has a dependency resource that the selected resource depends on to run based on the analysis of the resource deployment health dependency graph; and
perform an analysis of the dependency resource that the selected resource depends on to run in response to determining that the selected resource does have a dependency resource that the selected resource depends on to run based on the analysis of the resource deployment health dependency graph.

19. The computer program product of claim 18, wherein the program instructions further cause the computer to:
determine whether the dependency resource has a precondition for deployment in the virtual deployment of the container-based environment based on the analysis of the dependency resource;
perform an analysis of the precondition for deployment of the dependency resource in response to determining that the dependency resource does have a precondition for deployment in the virtual deployment of the container-based environment based on the analysis of the dependency resource;
determine whether the precondition for deployment of the dependency resource is satisfied based on the analysis of the precondition; and
mark the dependency resource as should not exist in the virtual deployment of the container-based environment in response to determining that the precondition for deployment of the dependency resource is not satisfied based on the analysis of the precondition.

20. The computer program product of claim 19, wherein the program instructions further cause the computer to:
determine whether the dependency resource exists in the container-based environment based on checking the API server in response to determining that the dependency resource does not have a precondition for deployment in the virtual deployment of the container-based environment based on the analysis of the dependency resource; and
mark the dependency resource as missing in response to determining that the dependency resource does not exist in the container-based environment.
